(19) United States
(12) Patent Application Publication
(10) Pub. No.: US 2006/0124071 A1
(43) Pub. Date: Jun. 15, 2006

(54) System for harvesting crustaceans

(75) Inventors: Angus Cameron Campbell, Brisbane (AU); Geoffrey William Harman, Brisbane (AU); John Day, Brisbane (AU)

Correspondence Address: SHOEMAKER AND MATTARE, LTD, 10 POST OFFICE ROAD - SUITE 110, SILVER SPRING, MD, 20910, US

(73) Assignee: Watermark Seafoods Pty Ltd, Pinkenba, Brisbane (AU)

(21) Appl. No.: 10/525,103

(22) PCT Filed: Aug. 19, 2003
(86) PCT No.: PCT/AU03/01055

§ 371 Date: Nov. 10, 2005

(30) Foreign Application Priority Data
Aug. 19, 2002 (AU) 2002950857

(51) Int. Cl. A01K 61/00

(52) U.S. Cl. 119/204; 119/213; 119/214

(57) ABSTRACT

An automated harvesting system for crustaceans comprising: (a) baskets (10) to individually house each crustacean and operationally complementary trays (17) to support one or more of these baskets (10) (b) harvesting means for harvesting each crustacean (c) monitoring means (33) for monitoring the moulting stage of each crustacean, the means including (i) an automated robotic camera adapted to periodically take images of a crustacean in its basket (10) (ii) a processor with software which can receive and analyze the images to determine whether a crustacean has moulted, where a moulted crustacean is indicated by the presence of two bodies in a basket (10), the processor also providing instructions to the harvesting means to remove a moulted crustacean from its basket (10).

### OBJECT OF THE INVENTION

It is an object of the present invention to provide a system for harvesting crustaceans that overcomes at least in part one or more of the aforementioned problems.

### SUMMARY OF THE INVENTION

In one aspect the present invention broadly resides in a system for harvesting crustaceans including

holding means for the housing of each crustacean in a separate compartment;

monitoring means for the automated monitoring of said crustaceans to determine whether they have molted; and

harvesting means for the removal of molted crustaceans from the holding means, wherein the monitoring means includes an automated camera means adapted to periodically take images of the crustaceans in the compartments, a processor with software which can receive and analyze the images to determine whether the crustacean has molted where a molted crustacean is indicated by the presence of two bodies in a compartment, and instruct the harvesting means to remove the molted crustacean from their compartment.

The term crustaceans refers to crabs, lobsters, Moreton Bay bugs, marron, prawns and any other suitable crustaceans that are capable of molting.

The automated camera means preferably takes images of each compartment at regular intervals. Preferably the regular intervals are spaced by at least the period it takes for the crustacean to molt. The regular intervals are preferably the length of time it takes for the crustacean to molt and the digestion of the discarded exoskeleton or formation of a new shell whichever is the earliest.

The automated camera means is preferably robotic being able to move the camera into a suitable position for taking the image of the crustacean in each compartment.

In another aspect the present invention broadly resides in a system for harvesting crustaceans including

holding means for the housing of each crustacean in a separate compartment;

monitoring means for the automated monitoring of said crustaceans to determine whether they have molted; and

harvesting means for the removal of molted crustaceans from the holding means, wherein the monitoring means includes an automated camera means adapted to periodically take images of the crustaceans in the compartments, a processor with software which can receive and analyze the images to determine whether the crustacean has molted where a molted crustacean is indicated by the presence of two bodies in a compartment, and instruct the harvesting means to remove the molted crustacean from their compartment, said automated camera means is robotically mounted being able to move the camera into a suitable position for taking the image of the crustacean in each compartment.

In a preferred embodiment the monitoring means is operatively associated with a feeding means which adds nutrients and feed (herein after referred to as food) to the crustacean in each compartment. The feeding means preferably includes a food storage bin and dispensing means. The feeding means is preferably robotic. The feeding means is preferably robotic with the camera means and dispensing means mounted on the same robot. In a more preferred embodiment the monitoring means is able to process an image of the crustacean in a compartment and determine the size of the crustacean thereby provide food as a percentage of the body weight of the crustacean. The amount of food to be provided to the crustacean may range between 1% and 15% of its body weight and more preferably 3% of its body weight. Preferably the monitoring means is able to determine whether there is food remaining in the holding means and increases or reduces the amount of food subsequently provided to the crustacean based on remaining food.

In another aspect the present invention broadly resides in a system for harvesting crustaceans including

holding means for the housing of each crustacean in a separate compartment;

monitoring means for the automated monitoring of said crustaceans to determine whether they have molted; and

harvesting means for the removal of molted crustaceans from the holding means, wherein the monitoring means includes an automated camera means adapted to periodically take images of the crustaceans in the compartments, a processor with software which can receive and analyze the images to determine whether the crustacean has molted where a molted crustacean is indicated by the presence of two bodies in a compartment, and instruct the harvesting means to remove the molted crustacean from their compartment, said automated camera means is robotically mounted being able to move the camera into a suitable position for taking the image of the crustacean in each compartment, wherein there is feeding means operatively associated with the monitoring means, said feeding means includes a dispensing means which is mounted on the same robot as the camera means.

When the food consumption is monitored over a period of time it provides an indication as to when the crustacean will molt as food consumption increases then decreases prior to molting. If food consumption is monitored over a period of time then this information may be used by the monitoring means as a guide to the molting cycle and the interval between taking images of each crustacean may vary as a consequence of taking into account this information. The interval between the taking of images of the crustacean in a compartment may lengthen and shorten depending on the crustacean's stage in the molting cycle.

Monitoring means may also include determination as to whether the molted crustacean is of marketable size. If the crustacean is of marketable size the crustacean is harvested. If the crustacean is not of marketable size the crustacean is returned to a basket after the exoskeleton has been removed or left in the basket with the exoskeleton being removed or digested.

The holding means preferably includes a basket for containing a single crustacean and a tray for locating the baskets. The basket preferably has a waste outlet and a clean water inlet. The clean water inlet is located above the waste outlet. A plurality of baskets are preferably arranged on each tray. Each tray preferably has a floor downwardly sloping towards the centre with a recess in the floor to allow collection of waste from the baskets. The baskets and tray are preferably operatively complementary with the clean water inlet locatable adjacent the tray water inlet, the waste outlet of the basket locatable adjacent the recess and the basket has inclined legs so that the floor of the basket is substantially horizontal when positioned on the tray.

There are preferably a plurality of trays supported on a racking system. The racking system may be a single level but preferably a multi-level system. The baskets, trays and racking system are preferably arranged to provide a reproducible modular system for housing the crustaceans.

Harvesting preferably includes moving the crustacean from the holding means and placing it in a collection container maintained at a temperature to slow activity. Preferably the temperature of the collection container is between 4 and 20° C. During harvesting it may be determined whether the molted crustacean in the collection container is of an acceptable marketable size. If the molted crustacean is determined to be of a marketable size then they are frozen and packed but if not they are returned to a holding means for further growth.

The harvesting means preferably includes an arm capable of grabbing and lifting the holding means in order to remove the molted crustacean. The monitoring means, feeding means, and the harvesting means is preferably mounted as a mobile unit able to check each holding means on the racking system.

In another aspect the invention broadly resides in holding means for housing crustacean in separate compartments wherein the holding means includes a basket for containing a single crustacean and a tray for locating one or more baskets, said basket is operatively complementary with the tray with a basket clean water inlet locatable adjacent the tray water inlet, a basket waste outlet locatable adjacent a tray floor recess, and inclined legs on the basket to maintain the floor of the basket substantially horizontal when the basket is positioned on the tray.

In another aspect the invention broadly resides in holding means for housing crustacean in separate compartments wherein the holding means includes a basket for containing a single crustacean and a tray for locating one or more baskets, said basket is operatively complementary with the tray with a basket clean water inlet locatable adjacent the tray water inlet, a basket waste outlet locatable adjacent a tray floor recess, and inclined legs on the basket to maintain the floor of the basket substantially horizontal when the basket is positioned on the tray, wherein a plurality of trays is supported on a racking system which forms a modular system.

In another aspect the invention broadly resides in an automated system of farming and harvesting crustaceans including

modular housing means including a plurality of holding means supported on a racking system, said holding means houses each crustacean in a separate compartment;

monitoring means for the automated monitoring of said crustaceans to determine whether they have molted;

feeding means for the adding of food to each compartment; and

harvesting means for the removal of molted crustaceans from the holding means, wherein the monitoring means includes an automated camera means adapted to periodically take images of the crustaceans in the compartments, a processor with software which can receive and analyze the images to determine whether the crustacean has molted where a molted crustacean is indicated by the presence of two bodies in a compartment, and instruct the harvesting means to remove the molted crustacean from their compartment.

Said automated camera means is preferably as described above.

Said automated camera means is preferably robotically mounted being able to move the camera into a suitable position for taking the image of the crustacean in each compartment.

Said automated camera means is preferably operatively associated with the feeding means as described above.

The modular housing means preferably includes an arrangement of holding means, trays and a racking system as described above.

The harvesting means is preferably as described above.

In another aspect the present invention broadly resides in apparatus for the harvesting or the farming and harvesting of crustaceans in the systems as described above. The apparatus includes holding means, monitoring means, harvesting means and feeding means. The various embodiments of each of these apparatus are described above and incorporated herein.

In another aspect the present invention broadly resides in a method of farming and harvesting crustaceans using the system for harvesting crustaceans or the system for farming and harvesting crustaceans as described above, including

obtaining a plurality of crustaceans;

positioning each of said crustaceans in individual holding means;

monitoring with the monitoring means each of said crustaceans to determine whether they have molted; and

harvesting with the harvesting means each of the molted crustaceans, wherein the monitoring involves using an automated camera means adapted to periodically take images of the crustaceans in the compartments, processing using a processor with software which can receive and analyze the images to determine whether the crustacean has molted where a molted crustacean is indicated by the presence of two bodies in a compartment, and instructing the harvesting means to remove the molted crustacean from their compartment.

Different embodiments of the methods are formed and incorporated herein by using different embodiments of the holding means, monitoring means, feeding means and harvesting means as described herein.

### BRIEF DESCRIPTION OF THE DRAWINGS

In order that the present invention be more readily understood and put into practical effect, reference will now be made to the accompanying drawings wherein:

FIG. 1 is a diagrammatic view of a basket holding a single crab;

FIG. 2 is a diagrammatic view of a tray for supporting a plurality of baskets;

FIG. 3 is a further diagrammatic view of a tray supporting a plurality of baskets;

FIG. 4 is a diagrammatic view of the racking system of the preferred embodiment;

FIG. 5 is a diagrammatic view of the camera and feeding mechanisms of the preferred embodiment;

FIG. 6 is a diagrammatic view of the monitoring robot;

FIG. 7 is a diagrammatic side view of the monitoring robot and racking system;

FIG. 8 is a diagrammatic view of the harvesting mechanism on the monitoring robot;

FIG. 9 is a planned diagrammatic view of the monitoring robot and docking unit;

FIG. 10 is a planned diagrammatic view of the racking system for farming and harvesting crustaceans; and

FIG. 11 is a side diagrammatic view of the racking system for farming and harvesting crustaceans.

### DETAILED DESCRIPTION OF THE PREFERRED EMBODIMENT

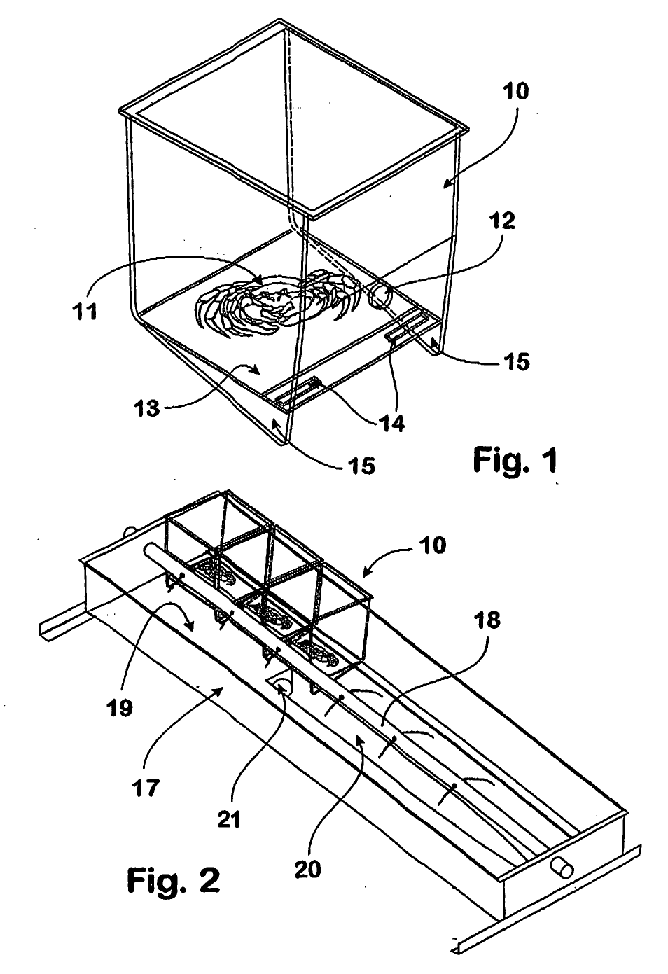

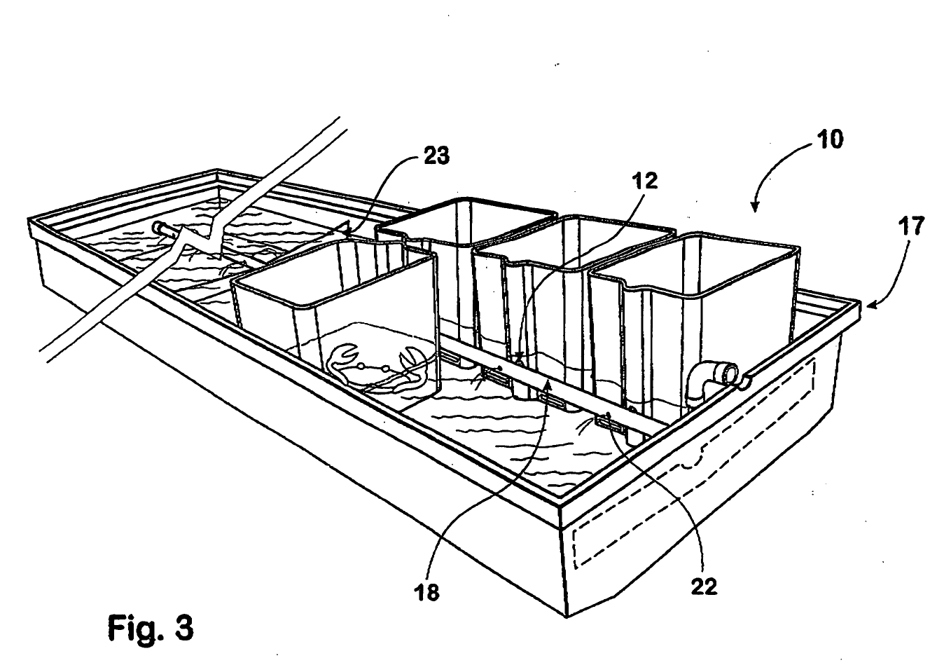

With reference to FIGS. 1, 2 and 3 there is shown a basket 10 for containing a single crustacean, which in FIG. 1 is a crab 11. The basket 10 has an aperture 12 midway in a side wall to allow introduction of clean water. The floor 13 of the container 10 has two adjacent slots 14 to allow for the discharge of waste. The floor 13 is supported by two triangular-shaped feet 15. The tray 17 includes an elongated pipe 18 through which clean water is passaged. Each of the baskets 10 is positioned against the pipe 18 in a manner where the floor 13 of the basket 10 is substantially horizontal. Floor 19 of tray 17 is substantially V-shaped and has an internal recess 20 that leads to a discharge outlet 21 where waste and water are discharged. Waste from the baskets 10 collects in the recess 20. The pipe 18 has a series of apertures 22 that align with apertures 12 in baskets 10 to allow introduction of clean water into baskets 10. The trays 17 may contain any suitable number of baskets 10 and a group of baskets 10 can be separated from each other by a bracket 23. In the preferred embodiment, there are eighteen baskets per tray.

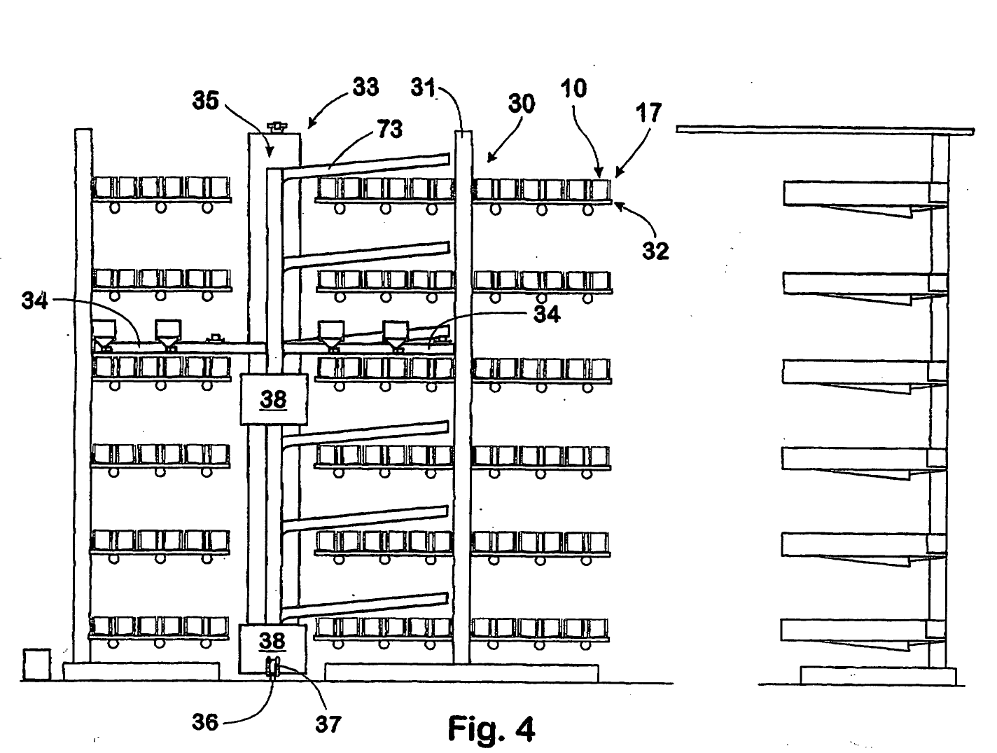

With reference to FIG. 4 there is shown a racking unit 30 which forms part of the racking system 29. The racking unit 29 includes an upright support 31 with six racks 32 extending laterally from both sides of the upright support 31. Three trays 17 each containing eighteen baskets 10 are positioned on each rack 32. That is, each rack 32 supports one hundred and eight baskets 10. Each racking unit 30 supports six hundred and forty eight baskets 10.

There is also shown the monitoring robot 33 which has six arms 34 extending from each side of the robot frame 35. The six arms 34 are capable of extending across each of the racks 32. (Not all of the arms 34 are shown in FIG. 4 in order to assist in the understanding of the monitoring robot 33.) The robot frame 35 moves along rails 36 via engagement with the guiding wheel 37. In some embodiments, there is also an overhead rail engagable by a top guide wheel which assists in guiding the robot frame 35. The robot frame 35 moves in a forwards and rearwards direction. The robot frame 35 also has two or more containers 38 for the collection of the molted crustacean. These containers 38 contain an ice slurry for reducing the physical and metabolic activity of the crustaceans. Each of the arms 34 has three feed apparatus 39 and three cameras 40.

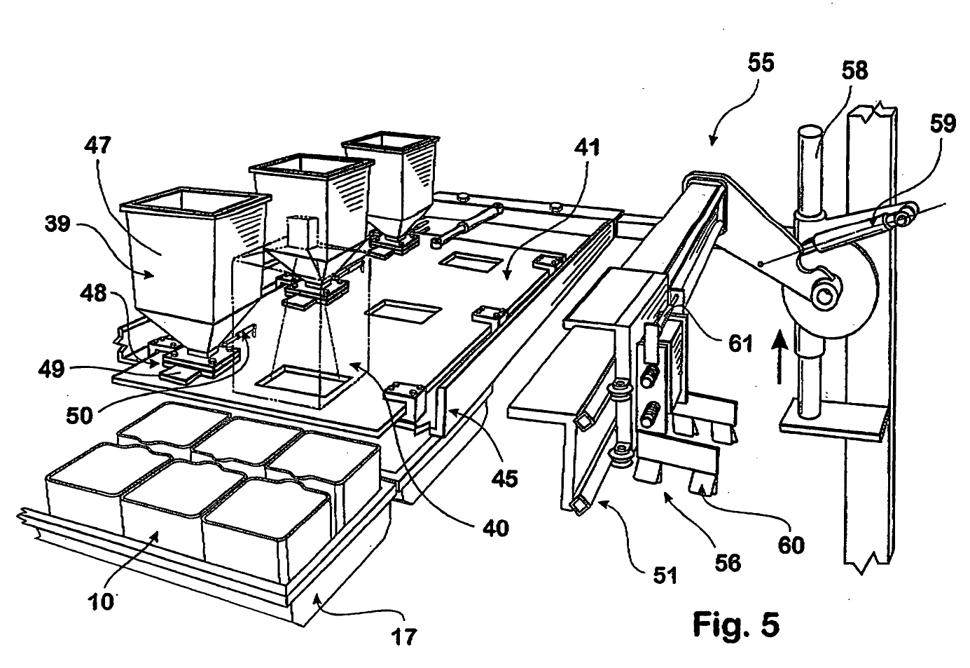

The arrangement of the feed apparatus 39 and cameras 40 is shown more clearly in FIG. 5. The feed apparatus 39 and cameras 40 are mounted on a slidable platform 41. The platform 41 is supported on L-shaped rails 45 and moves sideways with the assistance of a hydraulic ram 46. The movement of the platform 41 is substantially perpendicular to the forward and rearward movement of the robot frame 35. The feed apparatus 39 comprises a bin 47 and a metering gauge 48 consisting of a slidable plate 49 movable over an aperture (not shown) and actuated by hydraulic ram 50.

Each of the cameras 40 are arranged adjacent respective feed apparatus 39. In this manner images may be obtained during the feeding and harvesting process. To simplify the figures for ease of understanding the invention only a single camera 40 is drawn in phantom on the platform 41 whereas in operation there will be three cameras along platform 41.

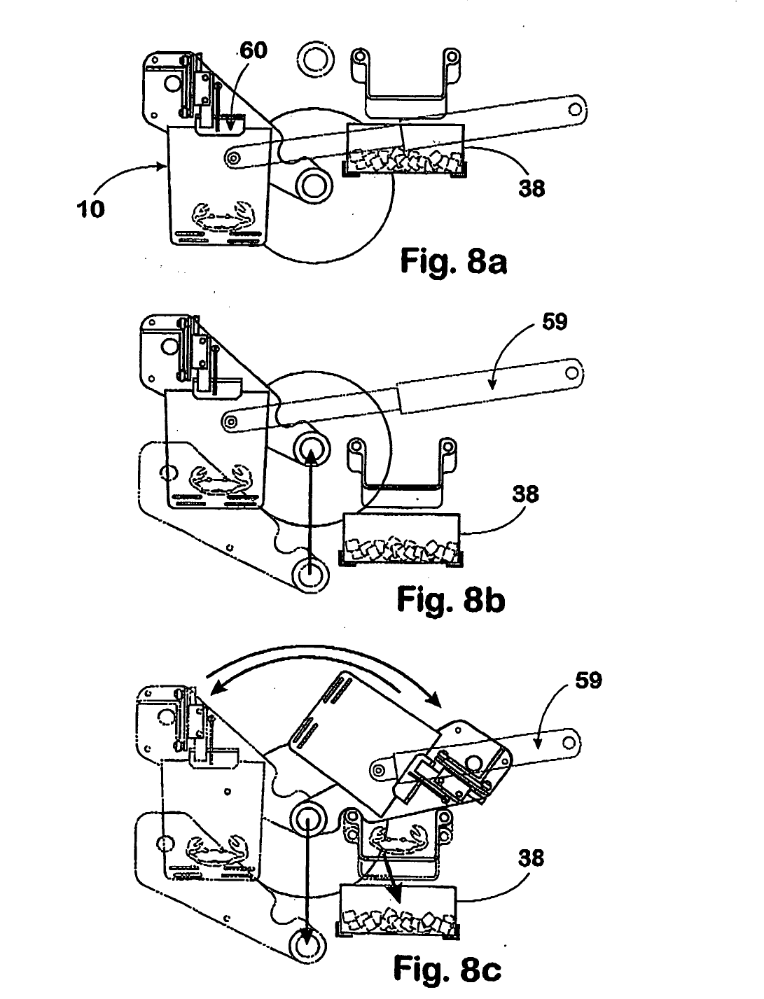

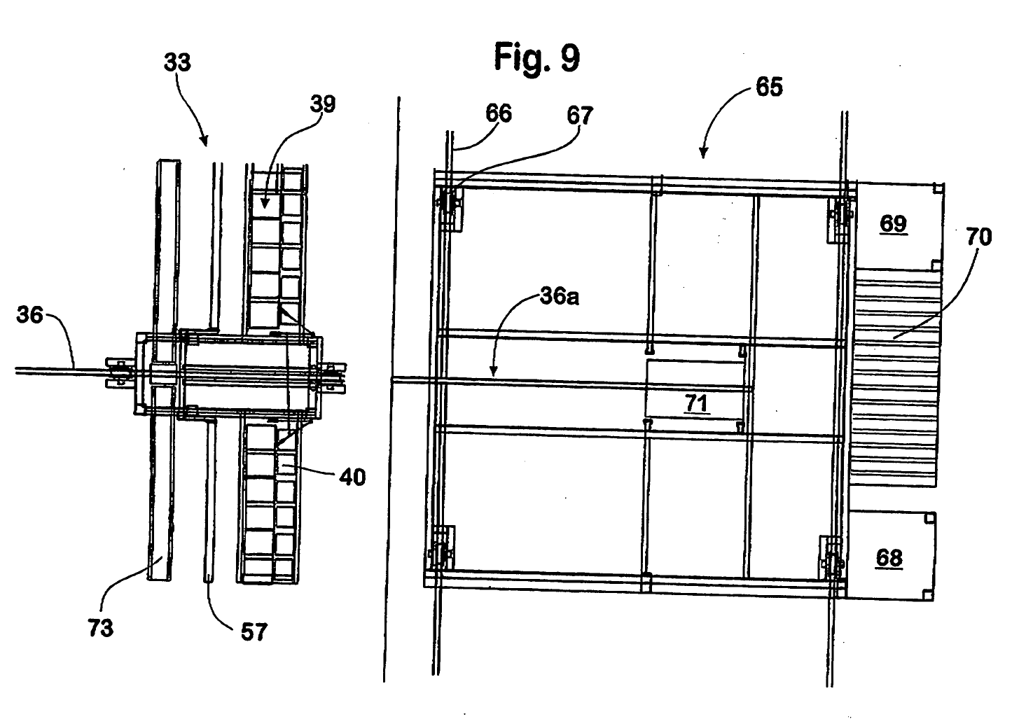

There is also shown the harvesting apparatus 55 attached to platform 41. The harvesting apparatus 55 comprises a gripping device 56 movable along a support rail 57. The support rail 57 is pivotally attached to a harvest arm 58 and can be moved about the pivot point with actuation by hydraulic ram 59. In operation the gripping device 56 moves to a basket 10 containing the molted crab, grips the basket 10 by opposing tangs 60 actuated by ram 61, and the basket 10 is raised and inverted so that the molted crab falls into a collection container 38. The molted crab passes into shoot 73 (shown in FIG. 9) and directed to the collection container 38. The basket 10 is then returned to its position in tray 17. The operation of the harvesting apparatus 55 is shown diagrammatically in FIGS. 8a to 8c.

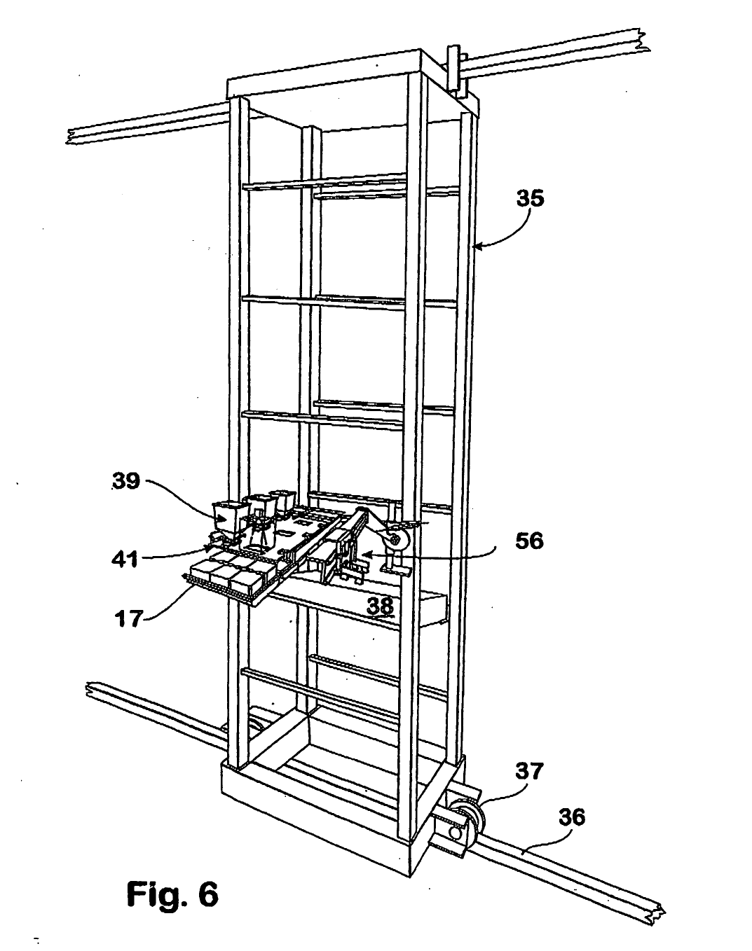

The platform 41 is further shown in FIG. 6 in perspective with the monitoring robot 33. Again for purposes of understanding the monitoring robot 33 only a single platform 41 is shown and in operation there are six platforms 41 on either side (12 in total) of the monitoring robot frame 35.

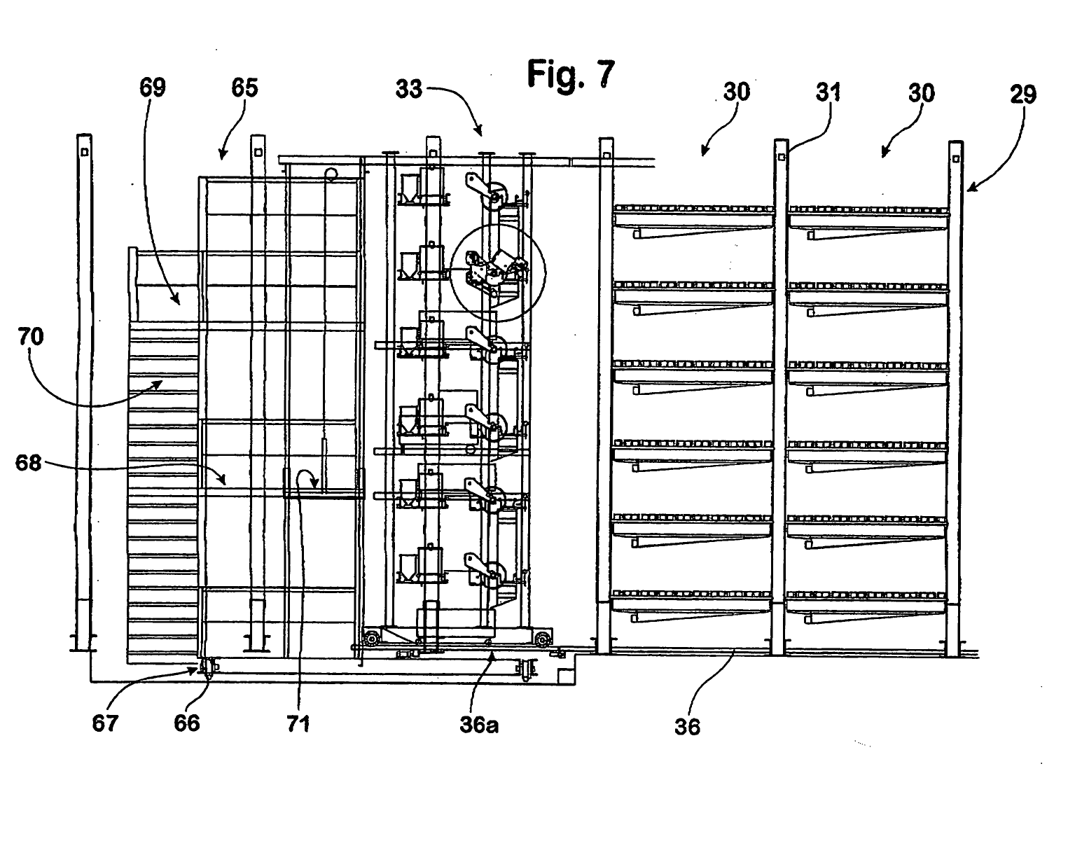

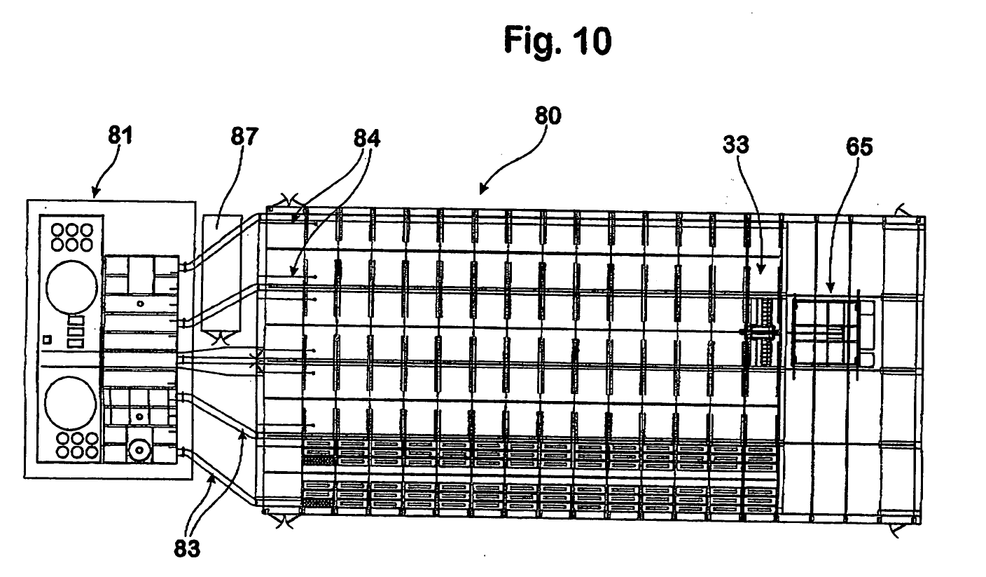

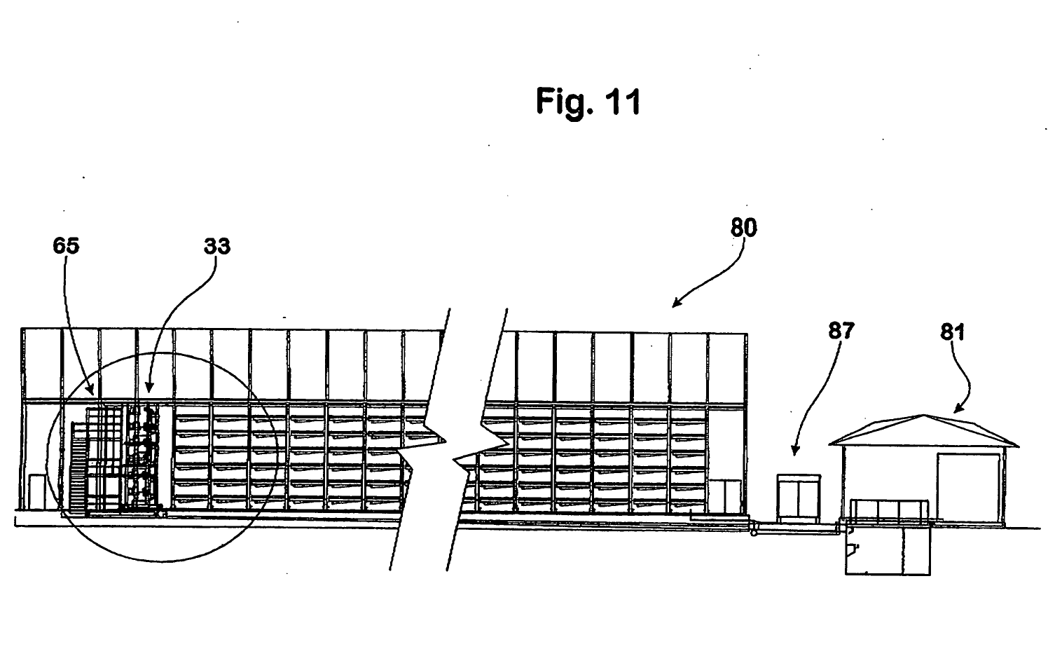

In FIG. 7 there is shown six platforms 41 extending from one side of the monitoring robot frame 35. The monitoring robot 33 is positioned in the docking station 65. The docking station 65 serves to service the monitoring robot 33 and reposition the monitoring robot 33 for operation along another row of the racking system 29. This is shown in FIG. 10. The monitoring robot 33 can move along rails 36 up and down the rows of the racking system 29. When one row has been serviced, the monitoring robot 33 docks with the docking station 65 by moving along aligned rail 36a which forms part of the docking station 65. The docking station 65 then moves along separate rails 66 engaged by guide wheels 67 to the next row. The docking station 65 moves forward and rearward and in a relatively perpendicular direction to the direction of movement of the monitoring robot 33. The docking station 65 has a lower platform 68 and an upper platform 69 accessed by stairs 70. There is also a lift 71 on which collection containers 38 can be raised and lowered from the robot frame 35. There are three collection containers 38 positioned on the robot frame 35 so that the molted crab product is not damaged by its fall from the basket 10.

FIGS. 10 and 11 provide different views of the racking system 29. The racking system 29 is housed in building 80 wherein the environmental conditions are carefully monitored. In the described embodiment there are approximately 70 racking units 30 in the racking system 29 thereby supporting approximately 36288 baskets 10 (and thus 36288 crabs) at any one time. The operation of the system is dependent on the provision of clean water. This is achieved through the water recycling and filtration plant 81 adjacent the building 80.

Waste is discharged from the trays 17 through discharge outlet 21 through pipes (not shown) connecting the discharge outlet 21 with internal piping (not shown) in the upright support 31. The internal piping connects with waste pipes 83 in the floor of the building 80 and discharges the waste to the water recycling and filtration plant 81. Clean water from the water recycling and filtration plant 81 is introduced via water pipes 84 in the floor of the building 80, passaged through internal water pipes in the upright support 31 and introduced into individual baskets 10 through pipe 18. Removal of waste and the introduction of clean water is preferably coordinated so that the baskets 10 always contain water. The removal of waste and the introduction of clean water may be coordinated by the monitoring robot 33.

In operation each basket 10 in the racking system 29 contains a crab. The monitoring robot 33 moves along the rows of racking units 30 providing food from feeding apparatus 39 to each basket 10 based on the presence of remaining food and approximate crab body weight. Typically the feed is metered so that a crab receives on average 5 grams of feed. The information concerning the presence of remaining food and approximate body weight is determined from images taken from adjacent camera 40. These images are processed by a processor which then transmits instructions to the feeding apparatus 39 regarding the amount of feed to be provided. The information from these images can be used to track the position of the crab in the 30 day molting cycle to give an approximation as to when the crab will next molt. Prior to molting the crab progressively increases then decreases the amount of feed it consumes. The images can also be used to determine whether the crab has molted by the presence of two bodies, one of which is the molted crab while the other is the exoskeleton or shell. If two bodies are detected, the processor provides instructions to the harvesting apparatus 55 to remove the crab to the collection container 38. The crab is removed to the collection container 38 at a predetermined time before a new shell has grown and to provide the best and consistent quality of crab meat product. If the size of the crab is unacceptable for the market, the crab is returned to a basket 10 for a further molting cycle. If the size of the crab is acceptable to the market, it is prepared for market by, for example, being frozen and packaged or sold live and delivered (by truck 87 for example in FIG. 10) to a consumer outlet, restaurant or for export.

### ADVANTAGES

The advantages of the present embodiment of the invention include individual housing of the crustaceans to avoid loss or damaged product from the aggressive behaviour of the crustaceans; automation of an otherwise labour intensive industry and thereby reducing the cost of the final product; provision of comparatively high quantities of product through intensive farming and automation and providing a consistently high quality product through the monitoring and timing of the molting process.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A system for harvesting crustaceans including
holding means for housing each crustacean in a separate compartment;
monitoring means for automatically monitoring said crustaceans to determine whether they have molted; and
harvesting means for removing molted crustaceans from the holding means, wherein the monitoring means includes an automated camera adapted to periodically take images of the crustaceans in the compartments, and a processor with software adapted to receive and analyze the images to determine whether the crustacean has molted where a molted crustacean is indicated by the presence of two bodies in a compartment, and instruct the harvesting means to remove the molted crustacean from their compartment.

2. A system for harvesting crustaceans including
holding means for housing each crustacean in a separate compartment;
monitoring means for automatically monitoring said crustaceans to determine whether they have molted; and
harvesting means for removing molted crustaceans from the holding means, wherein the monitoring means includes an automated camera adapted to periodically take images of the crustaceans in the compartments, and a processor with software adapted to receive and analyze the images to determine whether the crustacean has molted where a molted crustacean is indicated by the presence of two bodies in a compartment, and instruct the harvesting means to remove the molted crustacean from their compartment, said automated camera is robotically mounted being able to move the camera into a suitable position for taking the image of the crustacean in each compartment.

3. A system for harvesting crustaceans including
holding means for housing each crustacean in a separate compartment;
monitoring means for automatically monitoring said crustaceans to determine whether they have molted; and
harvesting means for removing molted crustaceans from the holding means, wherein the monitoring means includes an automated camera adapted to periodically take images of the crustaceans in the compartments, a processor with software which can receive and analyze the images to determine whether the crustacean has molted where a molted crustacean is indicated by the presence of two bodies in a compartment, and instruct the harvesting means to remove the molted crustacean from their compartment, said automated camera is robotically mounted being able to move the camera into a suitable position for taking the image of the crustacean in each compartment, wherein there is feeding means operatively associated with the monitoring means, said feeding means includes a dispensing means which is mounted on the same robot as the camera.

4. A system for harvesting crustaceans as claimed in claim 3, wherein the amount of food dispensed by the dispensing means ranges between 3% and 15% of the body weight of the crustacean.

5. A system for harvesting crustaceans as claimed in claim 1, wherein the holding means includes a basket for containing a single crustacean and a tray for locating one or more baskets.

6. A system for harvesting crustaceans as claimed in claim 1, wherein the holding means includes a basket for containing a single crustacean and a tray for locating one or more baskets, said basket is operatively complementary with the tray with a basket clean water inlet locatable adjacent the tray water inlet, a basket waste outlet locatable adjacent a tray floor recess, and inclined legs on the basket to maintain the floor of the basket substantially horizontal when the basket is positioned on the tray.

7. A system for harvesting crustaceans as claimed in claim 1, wherein the holding means includes a basket for containing a single crustacean and a tray for locating one or more baskets, said basket is operatively complementary with the tray with a basket clean water inlet locatable adjacent the tray water inlet, a basket waste outlet locatable adjacent a tray floor recess, and inclined legs on the basket to maintain the floor of the basket substantially horizontal when the basket is positioned on the tray, wherein a plurality of trays is supported on a racking system which forms a modular system.

8. An automated system of farming and harvesting crustaceans including
modular housing means including a plurality of holding means supported on a racking system, said holding means houses each crustacean in a separate compartment;
monitoring means for the automated monitoring of said crustaceans to determine whether they have molted;
feeding means for the adding of food to each compartment; and
harvesting means for the removal of molted crustaceans from the holding means, wherein the monitoring means includes an automated camera adapted to periodically take images of the crustaceans in the compartments, a processor with software which can receive and analyze the images to determine whether the crustacean has molted where a molted crustacean is indicated by the presence of two bodies in a compartment, and instruct the harvesting means to remove the molted crustacean from their compartment.

9. (canceled)

10. A method of farming and harvesting crustaceans, said method comprising steps of
obtaining a plurality of crustaceans;
positioning each of said crustaceans in individual holding means;
monitoring with the monitoring means each of said crustaceans to determine whether they have molted; and
harvesting with the harvesting means each of the molted crustaceans, wherein the monitoring involves using an automated camera adapted to periodically take images of the crustaceans in the compartments, processing using a processor with software which can receive and analyze the images to determine whether the crustacean has molted where a molted crustacean is indicated by the presence of two bodies in a compartment, and instructing the harvesting means to remove the molted crustacean from their compartment.
